(19) United States
(12) Patent Application Publication
(10) Pub. No.: US 2003/0038544 A1
(43) Pub. Date: Feb. 27, 2003

(54) Latch arrangement

(76) Inventor: Nigel Spurr, Shirley (GB)

Correspondence Address: CARLSON, GASKEY & OLDS, P.C., 400 WEST MAPLE ROAD, SUITE 350, BIRMINGHAM, MI, 48009, US

(21) Appl. No.: 10/226,388

(22) Filed: Aug. 23, 2002

(30) Foreign Application Priority Data
Aug. 24, 2001 (GB) 0120607.7

(51) Int. Cl. B60L 1/00

(52) U.S. Cl. 307/10.1

(57) ABSTRACT

A latch arrangement including a control device, a latch power operable between different security states by a latch security actuator, and a lock status indicator power operable between different lock status indicator positions by a lock status indicator actuator, in which the control device, on receiving a first input signal requiring a change in latch security state, generates a first output causing the latch to change its security state, and the lock status indicator to indicate the new latch security state, there being no mechanical transmission of movement between the lock status indicator and the latch.

This application claims priority to United Kingdom (GB) patent application number 0120607.7 filed on Aug. 24, 2001.

### BACKGROUND OF THE INVENTION

The present invention relates to latch arrangements.

Known door latches include control systems which upon receipt of an input signal, for example from a remote control device, send outputs to power actuators so as to either lock or unlock the latch.

To indicate if the latch is locked or unlocked, a lock status indicator such as a sill button is included in the latch arrangement. A mechanical transmission path exists between the sill button and the latch such that movement of the sill button can lock and unlock the latch. The position of the sill button indicates the lock status, typically up for unlocked and down for locked.

Door latches are located approximately half way up and towards the rear of a vehicle door such that the latch can engage with a striker, to retain the door in a closed position, the striker being mounted on the chassis of an associated vehicle. The sill button is located proximate the door latch to reduce the complexity of the mechanical transmission path between the sill button and the latch.

It is desirable to be able to position the sill button in other positions, such as towards the front of the vehicle door where it is more visible. However, the sill button is restricted in its location by the position of the door latch.

### SUMMARY OF THE INVENTION

An object of the present invention is to provide a latch arrangement where there is less restriction on the location of the sill button.

Thus according to the present invention, there is provided a latch arrangement including a control device, a latch power operable between different security states by a latch security actuator, and a lock status indicator power operable between different lock status indicator positions by a lock status indicator actuator, in which the control device, on receiving a first input signal requiring a change in latch security state, generates a first output causing the latch to change its security state and the lock status indicator to indicate the new latch security state, there being no mechanical transmission of movement between the lock status indicator and the latch.

According to a further aspect of the invention there is provided a latch arrangement including a control device, a latch power operable between an opened and closed conditions by a power unlatching actuator, the control device determining the security state of the latch, and a lock status indicator power operable between different lock status indicator positions by a lock status indicator actuator, in which the control device, on receiving a first input signal requiring a change in latch security state, changes the security state of the latch and generates a first output causing the lock status indicator to indicate the new latch security state, there being no mechanical transmission movement between the lock status indicator and the latch.

According to a further aspect of the invention there is provided a method of assembling a vehicle door including the steps of:—

providing a vehicle door

providing a latch power operable between different security states by a latch security actuator

providing a lock status indicator power operable between different lock status indicator positions by a lock status indicator actuator

assembling the latch, the latch security actuator, the lock status indicator and the lock status indicator actuator so as to form a latch arrangement subassembly, then

mounting the latch arrangement subassembly onto the vehicle door.

According to a further aspect of the invention there is provided a method of assembling a vehicle door including the steps of:—

providing a vehicle door

providing a latch power operable between different security states by a latch security actuator

assembling the latch and the latch security actuator so as to form a latch subassembly

providing a lock status indicator power operable between different lock status indicator positions by a lock status indicator actuator

assembling the lock status indicator and the lock status indicator actuator so as to form a lock status indicator subassembly

mounting the latch subassembly onto the vehicle door

mounting the lock status indicator subassembly onto the vehicle door.

According to a further aspect of the invention there is provided a method of assembling a vehicle door including the steps of:—

providing a vehicle door

providing a latch power operable between an opened and closed condition by a power unlatching actuator

providing a lock status indicator power operable between different lock status indicator positions by a lock status indicator actuator

assembling the latch, the power unlatching actuator, the lock status indicator and the lock status indicator actuator so as to form a latch arrangement subassembly

mounting the latch arrangement subassembly onto the vehicle door

According to a further aspect of the invention there is provided a method of assembling a vehicle door including the steps of:—

providing a vehicle door

providing a latch power operable between an opened and closed condition by a power unlatching actuator

assembling the latch and the power unlatching actuator so as to form a power latch subassembly

providing a lock status indicator power operable between different lock status indicator positions by a lock status indicator actuator

assembling the lock status indicator and the lock status indicator actuator so as to form a lock status indicator subassembly

mounting the power latch subassembly onto the vehicle door

mounting the lock status indicator subassembly onto the vehicle door.

According to a further aspect of the invention there is provided a method of assembling a vehicle including the steps of:—

providing a vehicle body

providing a kit of parts including a control device, a latch power operable between different security states by a latch security actuator, and a lock status indicator power operable between different lock status indicator positions by a lock status indicator actuator, in which the control device is capable of, on receiving a first input signal requiring a change in latch security state, is capable of generating a first output causing the latch to change its security state, and the lock status indicator to indicate the new latch security state, there being no mechanical transmission of movement between a lock status indicator and the latch,

then selectively assembling the control device the latch and the latch security actuator onto the vehicle and not assembling the lock status indicator and the lock status indicator actuator onto the vehicle.

### BRIEF DESCRIPTION OF THE DRAWINGS

The invention will now be described by way of example with reference to the accompanying drawings in which:—

FIG. 1 is a perspective view of the vehicle door assembly including a latch arrangement according to the present invention,

FIG. 2 is a schematic view of the latch arrangement of FIG. 1 according to the present invention,

FIG. 3 is a schematic view of a further embodiment of a latch arrangement according to the present invention, and

FIG. 4 is a schematic view of a further embodiment of a latch arrangement according to the present invention.

FIG. 5 is a schematic view of a further embodiment of the latch arrangement according to the present invention.

### DETAILED DESCRIPTION OF THE PREFERRED EMBODIMENT

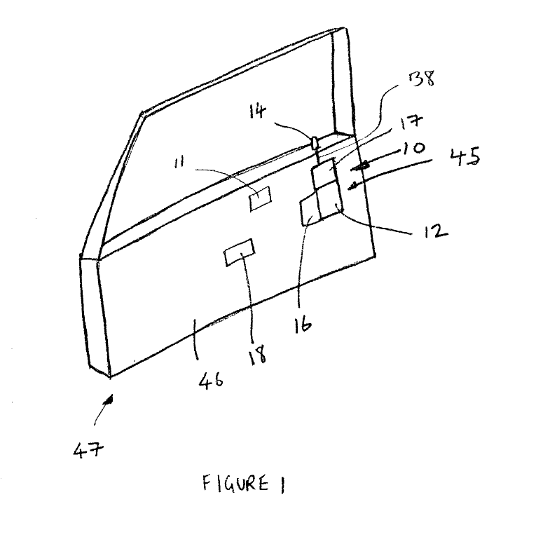

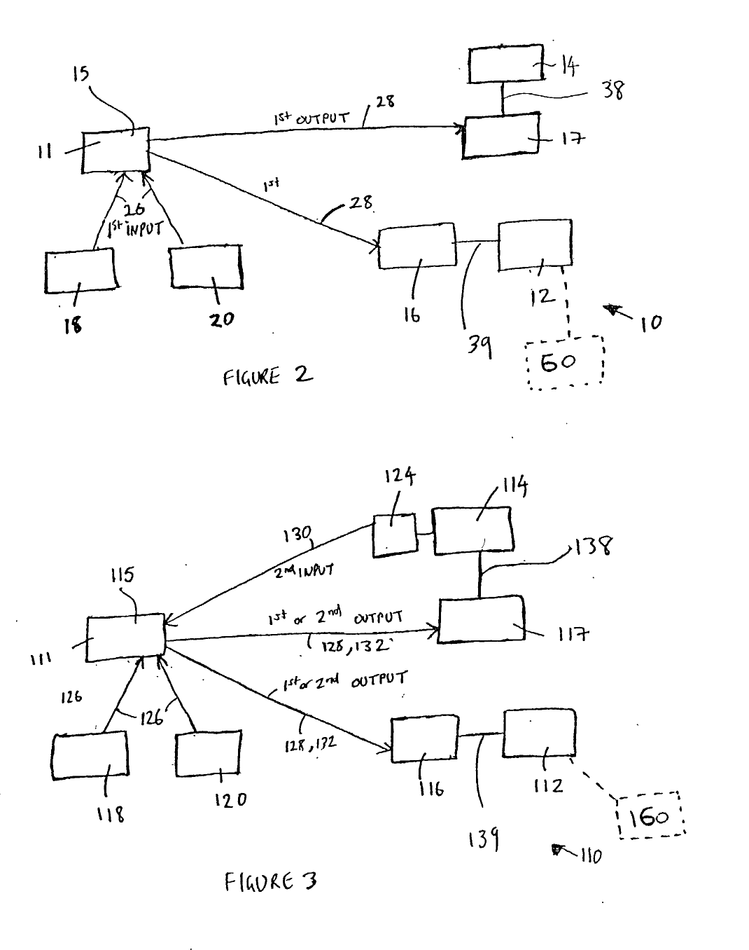

With reference to FIGS. 1 and 2, there is shown a vehicle door assembly 47, including a vehicle door 46 and a latch arrangement 10.

The latch arrangement includes a control device 11, a latch 12, a latch security actuator 16, a lock status indicator in the form of a sill button 14, and a sill button actuator 17.

With reference to FIG. 1, the location of the components of the latch arrangement is shown.

The control device is mounted on the vehicle door. In other embodiments the control device could be mounted on another part of an associated vehicle.

The control device is typically a microprocessor controlled device and is located proximate to, or is integral with an infrared detector 15.

The latch 12, sill button actuator 17 and sill button 14 are located at a position approximately half way up and towards the rear of the vehicle door. In other embodiments the sill button and sill button actuator can be located at other positions, for example towards the front of the vehicle door.

The latch is operable to releasably retain a striker mounted on an associated vehicle, such that when the striker is retained the vehicle door is closed. The latch is manually moved from its latched to its unlatched state by operation of an inside door handle or an outside door handle, there being a mechanical transmission path between the respective door handle and the latch.

The latch security actuator 16 is connected to the latch by a mechanical means 39, with the latch actuator mounted on the latch.

The latch security actuator is electrically powered to move the latch between its different latch security states. In this case the security states of the latch are locked and unlocked.

The sill button actuator is connected to the sill button by a mechanical transmission path in the form of a sill button rod 38, with the sill button actuator located proximate the sill button so as to limit the length of the sill button rod.

The sill button actuator is electrically powered to move the sill button between its different positions, with the sill button in a down position this indicates the latch is locked, and with the sill button in an up position this indicates the latch is unlocked.

In this case the sill button actuator is mounted on the latch, although in other embodiments the sill button actuator could be located remote from the latch, particularly if the sill button is located, for example, towards the front of the vehicle door.

With reference to FIG. 2, there is shown a schematic representation of the operation of the latch arrangement, indicating the different inputs and outputs of the control device, the operation being as follows:—

The control device receives a first input signal 26 which indicates that a change in the security state of the latch is required.

The first input signal is capable of being generated by a remote control device 20, such as an infra red device. Pressing an unlocking button (not shown) on the remote control device generates the first input signal to the control device.

The first signal is also capable of being generated by an inside handle 18. Manual movement of the inside handle from its locked position to its unlocked position operates an inside handle switch (not shown) which generates the first input signal to the control device.

Similarly the first signal is capable of being generated by a key barrel (not shown). Rotation of the key barrel using a key (not shown) operates a key barrel switch (not shown) which generates the first input signal to the control device.

On receiving the first input signal, requiring a change in the security state of the latch, the control device generates a first output 28. It can be seen from FIG. 1 that the first output is to the latch actuator 16 and also to the sill button actuator 17.

The latch actuator then moves the latch to its new security state via the mechanical means 39 and the sill button actuator moves the sill button, via rod 39 to reflect the new security state. For example, changing the security state of the latch, using the remote control device and/or the key barrel and/or the inside handle, from locked to unlocked will result in the sill button moving from its down position to its up position.

It should be noted that the movement of the sill button and the latch is as a result of actuation of respective actuators 17 and 16. The actuator movement is a result of the first output from the control device signalling actuation of each actuator. There is no mechanical transmission movement between the sill button and the latch.

In a further embodiment security states could alternatively be locked/superlocked and unlocked. Thus if the latch is in a superlocked or locked condition the sill button will be in its down position, there being no visible differentiation between the locked and superlocked conditions.

In another embodiment, it would be possible to employ a lock status indicator with three positions to indicate the latch security state, for example, a first position for superlocked, a second position for locked, and a third position for unlocked.

With reference to FIG. 3, there is shown an alternative latch arrangement, with components performing the same function as those in FIG. 2 numbered 100 greater.

The embodiment of FIG. 3 differs in operation from that of FIG. 2 in that independent movement of the sill button generates a second input signal 130.

Independent actuation of the sill button is distinct from the actuation of the sill button actuator as a result of the sill button actuator receiving the first output signal. Independent actuation of the sill button would typically be as a result of a vehicle occupant moving the sill button up or down manually, i.e. by hand.

Independent actuation of the sill button operates a switch 124, with the switch generating the second input signal to the control device 111.

Note that the switch can be located in the mechanical transmission path 138 between the sill button and the sill button actuator or within the sill button actuator itself.

On receiving the second input signal, the control device generates a second output 132. The latch actuator then moves the latch to its new security state via the mechanical means 139.

It can be seen from FIG. 3 that the second output is only sent to the latch actuator 16. There is no output to the sill button actuator as a result of the second input. Clearly the sill button already indicates the new security state since it has been moved by independent actuation, and hence there is no requirement for a first output to the sill button actuator.

Note however that there will be a first output to the sill button actuator when the control device receives a first input signal 126.

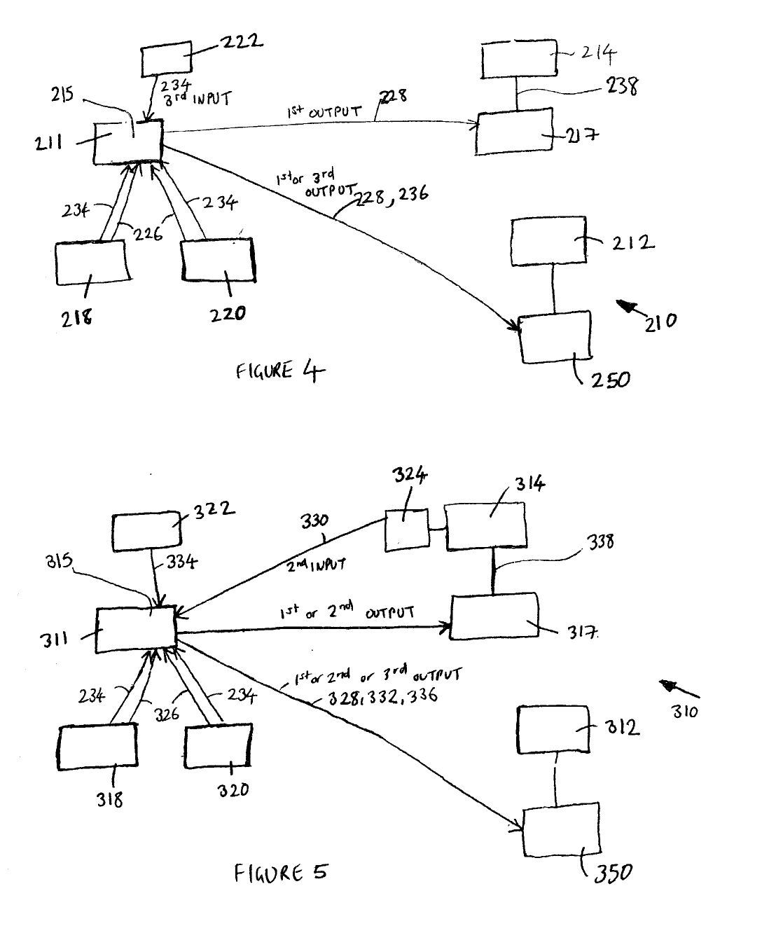

With reference to FIG. 4 there is shown an alternative latch arrangement with components performing the same function as those in FIG. 2 numbered 200 greater.

The latch 212 is a power open latch, i.e. the latch is powered from its latched to its unlatched state by a power unlatching actuator 250. In this case operation of the actuator 250 is the only way of releasing the door, there being no mechanical connection from say a door handle to the latch. Note that this can be contrasted with the manual latch of FIGS. 2 and 3 which are manually unlatched.

The power unlatching actuator is electrically powered, although in other embodiments the latch need not be electrically powered, for example the latch could be pneumatically powered.

The operation of the power open latch is as follows.

The control device receives a third input signal 234 which indicates that the latch is required to be unlatched so that the door can open

The third input signal is capable of being generated by a remote control device 220, in that pressing an unlatching button (not shown) on the remote control device generates the third input signal to the control device.

The third input signal is also capable of being generated by an inside handle 218. Manual movement of the inside handle from its locked or unlocked position to its release position operates an inside handle switch (not shown) which generates a third input signal to the control device.

The third input signal is also capable of being generated by an outside handle 222. Movement of the outside handle operates an outside handle switch (not shown) which generates the third input signal to a control device.

On receiving the third input signal, the control device, dependant upon the security state of the latch, generates a third output 236. It can be seen in FIG. 1 that the third output is sent to the power unlatching actuator 250. The power unlatching actuator then unlatches the latch. Note that no visible indication of the latch status is required since it is apparent whether or not the door is open or closed.

With reference to FIG. 5, there is shown an alternative latch arrangement, with components performing the same function as those in FIG. 4 numbered 100 greater.

The embodiment of FIG. 5 differs in operation from that of FIG. 4 in the same way that the embodiment of FIG. 3 differs from that of FIG. 2, i.e. independent movement of the sill button generates a second input signal 330.

It should be noted that in the embodiments of FIGS. 1 to 5, operation of the outside handle will not unlatch the latch if the latch is locked or superlocked.

Similarly, operation of the inside handle will not unlatch the latch if the latch is superlocked, but will unlatch the latch if the latch is locked.

Clearly remote control device used in conjunction with the embodiments shown in FIGS. 2 and 3 only required to produce a signal indicating a change of latch security status, whereas remote control device for use with the embodiments shown in FIGS. 4 and 5 preferably includes both means of indicating a change in security status and also means of indicating and opening requirement for the latch.

As mentioned above, the embodiments shown in FIGS. 2 and 3 are latches which have to be manually operated to be opened. In a modified embodiment a power unlatching actuator (shown in dotted outline as 60 and 160 respectively) can be included. Thus, for example, operation of an outside door handle will cause power unlatching actuator 60 to operate. If the door is in an unlocked condition this operation will be transmitted by a transmission path to the latch to open the door.

However, if the latch is in a locked condition operation of the power latch and actuator will not be transmitted to the latch, which therefore will not open.

Operation of power unlatching actuators 60 and 160 can be contrasted with operation of power unlatching actuators 250 and 350 thus operation of an outside door handle of the embodiment shown in FIG. 4 when the latch is in a locked condition will produce a third input signal 234 to the control device 211. However, since the latch is in a locked condition no third output signal is generated by the control device and hence the unlatching actuator 250 is not caused to actuate.

Thus, it can be seen that in the embodiment shown in FIGS. 4 and 5, by providing suitable software to the microprocessor control device 211, 213, it is possible to provide for changing the security status of the latch since the latch can only be operated by the power unlatching actuator 250, 350 which in turn is controlled solely by the control device 211, 213. In particular embodiments shown in FIGS. 4 and 5 do not include a latch security actuator equivalent to items 16 and 116 as shown in FIGS. 2 and 3.

With reference to FIG. 1, it can be seen that the latch 12, the latch security actuator 16, the lock status indicator in the form of a sill button 14 and the sill button actuator 17 have been assembled to form a latch arrangement subassembly 45. It should be emphasised however that during operation of this subassembly, there is no mechanical transmission of movement between the lock status indicator and the latch.

The latch arrangement subassembly 45 is then mounted on the vehicle door 46. Alternatively the latch assembly can be mounted on a vehicle door module (not shown), the vehicle door module being mounted on the vehicle door.

This allows the latch arrangement subassembly to be assembled remote from the vehicle door or vehicle door module, for example, by a vehicle door latch manufacturer, and later mounted on the vehicle door, for example on a vehicle production line.

Alternatively, the latch and the latch security actuator can be provided as a latch subassembly, and the sill button and sill button actuator provided as a lock status indicator subassembly in the form of a sill button subassembly. The sill button can then be positioned remote from the latch subassembly, for example towards the front of the vehicle door.

In another embodiment, a latch, a power unlatching actuator, a sill button and a sill button actuator can be assembled to form a latch arrangement subassembly. In this embodiment, the latch and power unlatching actuator and the sill button and sill button actuator can be provided as a latch subassembly and a sill button subassembly respectively, or as a complete latch arrangement subassembly.

Control device 11 is located on the vehicle door or alternatively on part of a vehicle chassis, and can be mounted prior to or after the mounting of the subassemblies.

The invention also allows the same latch and latch actuator to be used both on a vehicle with an associated sill button and on a vehicle where a sill button is not required thus it is possible, on an assembly line, to provide a kit of parts comprising for example those components shown in FIG. 2, and where a particular vehicle requires a sill button, for all those components to be assembled onto the vehicle, and where another vehicle does not require a sill button, to only selectively assemble onto the vehicle certain components, excluding in particular sill button 14, rod 38, lock status indicator actuator 17.

1. A latch arrangement including a control device, a latch power operable between different security states by a latch security actuator, and a lock status indicator power operable between different lock status indicator positions by a lock status indicator actuator, in which the control device, on receiving a first input signal requiring a change in latch security state, generates a first output causing the latch to change its security state and the lock status indicator to indicate the new latch security state, there being no mechanical transmission of movement between the lock status indicator and the latch.

2. A latch arrangement according to claim 1 in which the latch is a power unlatching latch.

3. A latch arrangement according to claim 2 in which the power unlatching latch is electrically powered.

4. A latch arrangement according to claim 1 in which the latch actuator is electrically powered.

5. A latch arrangement according to claim 1 in which the lock status indicator actuator is electrically powered.

6. A latch arrangement according to claim 1 in which the latch security states are locked/superlocked and unlocked.

7. A latch arrangement according to claim 1 in which the first input signal is capable of being generated by operation of an inside door handle.

8. A latch arrangement according to claim 1 in which the first input signal is capable of being generated by operation of a remote control device.

9. A latch arrangement according to claim 1 in which the latch security states are locked and unlocked.

10. A latch arrangement according to claim 1 in which the lock status indicator is a sill button.

11. A latch arrangement according to claim 1 in which the control device, on receiving a second input signal, as a result of independent actuation of the lock status indicator, changes the security status of the latch.

12. A latch arrangement according to claim 1 in which the control device, on receiving a second input signal, as a result of independent actuation of the lock status indicator, generates a second output causing the latch to change its security state.

13. A latch arrangement according to claim 2 in which the control device, on receiving a third input signal generates a third output causing the latch to power unlatch.

14. A latch arrangement including a control device, a latch power operable between an opened and closed conditions by a power unlatching actuator, the control device determining the security state of the latch, and a lock status indicator power operable between different lock status indicator positions by a lock status indicator actuator, in which the control device, on receiving a first input signal requiring a change in latch security state, changes the security state of the latch and generates a first output causing the lock status indicator to indicate the new latch security state, there being no mechanical transmission movement between the lock status indicator and the latch.

15. A latch arrangement according to claim 14 in which the first input signal is capable of being generated by operation of an inside door handle.

16. A latch arrangement according to claim 14 in which the first input signal is capable of being generated by operation of a remote control device.

17. A latch arrangement according claim 14 in which the latch security states are locked and unlocked.

18. A latch arrangement according to claim 14 in which the latch security states are locked/superlocked and unlocked.

19. A latch arrangement according to claim 14 in which the lock status indicator is a sill button.

20. A latch arrangement according to claim 14 in which the control device, on receiving a second input signal, as a result of independent actuation of the lock status indicator, changes the security status of the latch.

21. A latch arrangement according to claim 14 in which the control device, on receiving a second input signal, as a result of independent actuation of the lock status indicator, generates a second output causing the latch to change its security state.

22. A latch arrangement according to claim 20 in which the independent actuation of the lock status indicator moves a switch, with the switch generating the second input signal.

23. A latch arrangement according to claims 20 in which independent actuation of the lock status indicator is by manual actuation.

24. A latch arrangement according claim 14 in which the control device, on receiving a third input signal generates a third output causing the latch to power unlatch.

25. A latch arrangement according to claim 24 in which the third input signal is capable of being generated by an inside door handle.

26. A latch arrangement according to claim 24 in which the third input signal is capable of being generated by an outside door handle.

27. A latch arrangement according to claim 24 in which the third input signal is capable of being generated by a remote control device.

28. A method of assembling a vehicle door including the steps of:
providing a vehicle door
providing a latch power operable between different security states by a latch security actuator
providing a lock status indicator power operable between different lock status
indicator positions by a lock status indicator actuator
assembling the latch, the latch security actuator, the lock status indicator and the lock status indicator actuator so as to form a latch arrangement subassembly, then
mounting the latch arrangement subassembly onto the vehicle door.

29. A method of assembling a vehicle door according to claim 28 including the step of providing a control device on the door.

30. A method of assembling a vehicle door including the steps of:
providing a vehicle door
providing a latch power operable between different security states by a latch security actuator
assembling the latch and the latch security actuator so as to form a latch subassembly
providing a lock status indicator power operable between different lock status indicator positions by a lock status indicator actuator
assembling the lock status indicator and the lock status indicator actuator so as to form a lock status indicator subassembly
mounting the latch subassembly onto the vehicle door
mounting the lock status indicator subassembly onto the vehicle door.

31. A method of assembling a vehicle door according to claim 30 including the step of providing a control device on the door.

32. A method of assembling a vehicle door including the steps of:
providing a vehicle door
providing a latch power operable between an opened and closed condition by a power unlatching actuator
providing a lock status indicator power operable between different lock status indicator positions by a lock status indicator actuator
assembling the latch, the power unlatching actuator, the lock status indicator and the lock status indicator actuator so as to form a latch arrangement subassembly mounting the latch arrangement subassembly onto the vehicle door.

33. A method of assembling a vehicle door according to claim 33 including the step of providing a control device on the door.

34. A method of assembling a vehicle door including the steps of:
providing a vehicle door
providing a latch power operable between an opened and closed condition by a power unlatching actuator
assembling the latch and the power unlatching actuator so as to form a power latch subassembly
providing a lock status indicator power operable between different lock status indicator positions by a lock status indicator actuator
assembling the lock status indicator and the lock status indicator actuator so as to form a lock status indicator subassembly
mounting the power latch subassembly onto the vehicle door
mounting the lock status indicator subassembly onto the vehicle door.

35. A method of assembling a vehicle door according to claim 34 including the step of
providing a control device on the door.

36. A method of assembling a vehicle including the steps of:
providing a vehicle body
providing a kit of parts including a control device, a latch power operable between different security states by a latch security actuator, and a lock status indicator power operable between different lock status indicator positions by a lock status indicator actuator, in which the control device is capable of, on receiving a first input signal requiring a change in latch security state, generating a first output causing the latch to change its security state, and the lock status indicator to indicate the new latch security state, there being no mechanical transmission of movement between a lock status indicator and the latch,
then selectively assembling the control device the latch and the latch security actuator onto the vehicle and not assembling the lock status indicator and the lock status indicator actuator onto the vehicle.

37. A method of assembling a vehicle including the steps of:
providing a vehicle body
providing a kit of parts including a control device, a latch power operable between an open and closed condition by a power unlatching actuator, the control device being capable of determining the security state of the latch, and a lock status indicator power operable between different lock status indicator positions by a lock status indicator actuator in which the control device is capable of, on receiving a first input signal requiring a change in the latch security state, changing in the security state of the latch, and generating a first output causing the lock status indicator to indicate the new latch security state, there being no mechanical transmission movement between the lock status indicator and the latch,
then selectively assembling the control device, the latch, the power unlatching actuator on to the vehicle and not assembling the lock status indicator and lock status indicator actuator onto the vehicle.
